(19) United States
(12) Patent Application Publication
(10) Pub. No.: US 2008/0071840 A1
(43) Pub. Date: Mar. 20, 2008

(54) Introducing Multi-Level Nested Kits Into Existing E-Commerce Systems

(76) Inventors: Viswanath Srikanth, Chapel Hill, NC (US); Rajesh Balasubramaniam, Cary, NC (US); Marcelo Perazolo, Cary, NC (US); Carlos Hoyos, Morrisville, NC (US)

Correspondence Address: HAMILTON & TERRILE, LLP;IBM RSW, P.O. BOX 203518, AUSTIN, TX, 78720, US

(21) Appl. No.: 11/531,722

(22) Filed: Sep. 14, 2006

(51) Int. Cl. G06F 17/30

(52) U.S. Cl. 707/200

(57) ABSTRACT

A representation of static and dynamic nested kits in an existing e-commerce ordering system to facilitate migration of existing e-commerce systems to support nested kits. Physical components of a nested kit remain in an order item table of a database, but non-physical components are placed in a separate database table, and the in-memory representation of the nested kit is represented as a hash-map of nodes, where each node is aware of its parent and child relationship.

### BACKGROUND OF THE INVENTION

Today's on-line consumers are becoming more sophisticated and desire products that can be custom-tailored from a variety of options to meet their needs. This has resulted in a market trend sometimes referred to as mass customization, which has become especially popular when ordering products such as custom-configured personal computers. Large and small online retailers wish to provide flexible product configuration capabilities for their customers.

Nested kits are product components that contain other components within them, and these other components may themselves contain yet other components within them, and so forth, continuing through additional levels of product components and options. An example would be a rack of computer servers, with each server containing one or more central processing units (CPUs), hard drives, and memory cards, with each memory card containing one or more memory modules. These kits provide configuration flexibility when ordering products and it is not uncommon in business-to-business (B2B) e-commerce scenarios for kits to have five or more levels of detail. In some cases, the vendor predetermines the product component composition of each nested kit (i.e., a static nested kit), and in other cases, the customer is allowed to pick and choose the components they desire, which results in the formation of a dynamic nested kit.

Many of today's e-commerce systems do not support kits at all. Few of these systems support kits with a single level of component detail, and fewer still support nested kits. Those e-commerce systems that do support nested kits are typically developed as extensions of a single-level kit, and are generally implemented using a parent-child relationship approach that fans out into a tree-like structure that simply uses a single table in a database to represent all levels of the kit. This approach present inherent system migration challenges for merchants considering implementation of nested kits. For example, the single table that houses the nested kit is typically traversed multiple times during the processing of an order for pricing, inventory & fulfillment purposes. Products that include nested kits are thus slower to process due to the increased number of traversals of the table during order processing, which adversely affects the time it takes to complete the order. Other issues include having to change database traversal routines in order to support product components that are neither at the top level, or the leaf level of the product component hierarchy tree. Similarly, changes are required to inventory and pick-batch generation routines, which are generally oriented just to physical product components. Likewise, some components of a nested kit may not be priced during order placement. Instead, they are priced during order processing since pricing may be affected by the overall contents of the order. As a result, changes to pricing routines must be made such that they skip multiple lines in the database table as the order is processed. In addition, it can be cumbersome to display and navigate the contents of a nested kit from a client browser when its components are represented in-memory as a tree. Furthermore, in many cases this in-memory representation of the nested kit is also used for pack-slip generation, which results in inefficiencies since the tree structure now needs to be navigated by this routine, resulting in fulfillment processing delays.

For example, FIGS. 1a-b depict a customer order 100 that does not comprise kit components. FIG. 1a shows customer order 102, comprising book 104, cape 116 and hat 118. Customer order 102 further comprises an Order_ID data field implemented as a relational link to book 104, cape 116 and hat 118, which likewise comprise an Order_ID data field depicted with the same value.

FIG. 1b shows Order database table 120 and OrderItem database table 130 as commonly implemented to assemble items comprising an order. Order database table 120 comprises database fields Order_ID 122, Order_Date 124, Order_Time 126, and Order_Table 128, but not individual order items. OrderItem database table 130 comprises database fields OrderItem_ID 132, Catalog_ID 134, Item_ID 136, item Quantity 138, item Description 140, item Unit_Price 142, item Total_Price 144 and Order_ID 146. In this depiction, the contents of database fields Order_ID 146, OrderItem_ID 132, Catalog_ID 134, and Item_ID 136, corresponding respectively to book 104, cape 116, and hat 118 comprising customer order 102. In this depiction, Order database table 120 and OrderItem database table 130 are relationally linked by database fields Order_ID 122 and Order_ID 146 respectively.

Also for example, FIGS. 2a-b depict a customer order comprising single level kit components 200 as commonly implemented in an OrderItem database table 130 and KitComponentList database table 250. FIG. 2a shows customer order 202, comprising book order item 204 and costume kit 210. Customer order 102 further comprises an Order_ID data field implemented as a relational link to book order item 104 and costume kit 210, which likewise comprise an Order_ID data field depicted with the same value. Costume kit 210 comprises single level kit 208, further comprising cape order item 116 and hat order item 118.

FIG. 2b shows Order database table 120, OrderItem database table 130, and KitComponentList database table 250 as commonly implemented to assemble individual order items as components of single level kit 208 comprising order 102. Order database table 120 comprises database fields Order_ID 122, Order_Date 124, Order_Time 126, and Order_Table 128, but not individual order items. OrderItem database table 130 comprises database fields OrderItem_ID 132, Catalog_ID 134, Item_ID 136, item Quantity 138, item Description 140, item Unit_Price 142, item Total_Price 144, Order_ID 146 and logical field KIT 248. KitComponentList database table 250 comprises database fields OrderItem_ID 252, Catalog_ID 254, Item_ID 256, item Quantity 258, item Description 260, item Unit_Price 262 and logical field Mandatory 264. In this depiction, Order database table 120 and OrderItem database table 130 are relationally linked by their respective Order_ID database fields 122 and 146.

In this depiction, the contents of OrderItem database table 130 comprising order 102 are relationally linked to Order database table 120 by their respective OrderID database fields 146 and 122. The contents of KitComponentList database table 250 comprising costume kit 210 are in turn relationally linked to OrderItem database table 130 by their respective OrderItem_ID database fields 252 and 132. In a similar manner, the value of logical field KIT 248 comprising OrderItem database table 130 signifies whether the value of database field OrderItem_ID 132 comprises single level kit 208, which further comprises Costume kit 210. Likewise, the value of logical field Mandatory 264, comprising KitComponentList database table 250, signifies whether kit components sharing the same value of database field OrderItem_ID 252 are mandatory components comprising single level kit 208. Thus, the single level kits as shown in this depiction run against KitComponentList database table 250.

### BRIEF SUMMARY OF THE INVENTION

According to one aspect of the present invention, a method comprises storing physical components of a nested kit in an order item table of a database, storing the entire nested kit relationship in a separate table, and providing a representation of the nested kit as a hash map of nodes where each node is aware of a node parent relationship and a node children relationship.

According to another aspect of the present invention, a system comprises a processor, a data bus coupled to the processor, and a computer-usable medium embodying computer program code. The computer-usable medium is coupled to the data bus. The computer program code comprises instructions executable by the processor and configured for storing physical components of a nested kit in an order item table of a database, and providing an in memory representation of the nested kit as a hash map of nodes where each node is aware of a node parent relationship and node children relationship.

According to another aspect of the present invention, a computer program product comprises a computer usable medium having computer usable program code embodied therewith. The computer usable program code comprises computer usable program code configured to store physical components of a nested kit in an order item table of a database and computer usable program code configured to provide a representation of the nested kit as a hash map of nodes where each node is aware of a node parent relationship and node children relationship.

### BRIEF DESCRIPTION OF THE SEVERAL VIEWS OF THE DRAWINGS

FIGS. 1a-b depict a prior art implementation of a customer order that does not comprise kit components;

FIGS. 2a-b depict a prior art implementation of a customer order comprising single level kit components;

FIG. 3 depicts an exemplary client computer in which the present invention may be implemented;

FIGS. 4a-b depict a customer order comprising multi-level, nested kit components, and;

FIGS. 5a-b depict a block diagram of a nested kit in a hash map format.

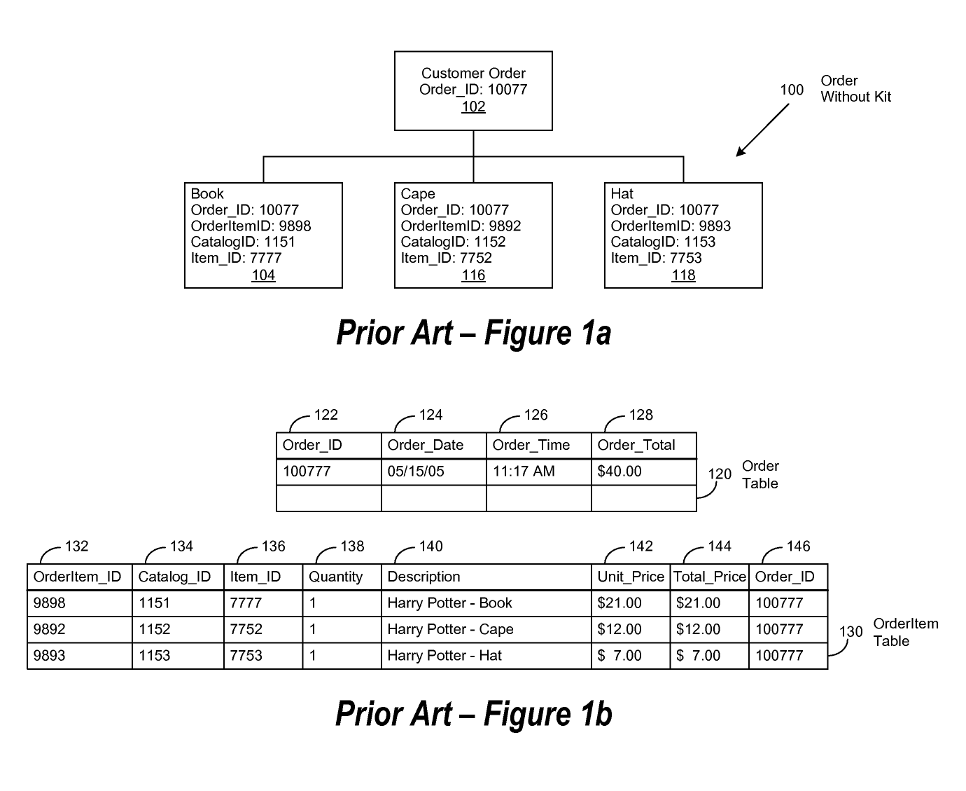

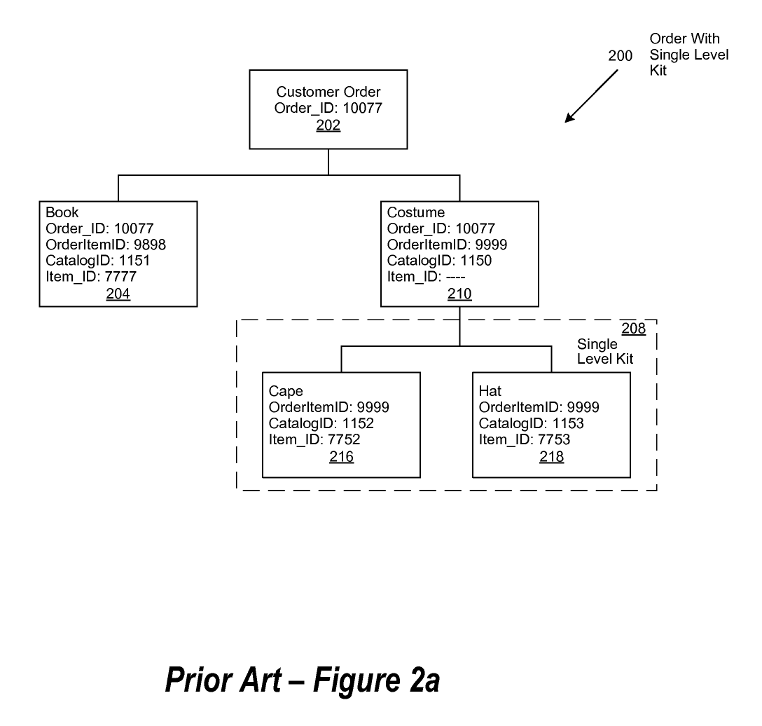

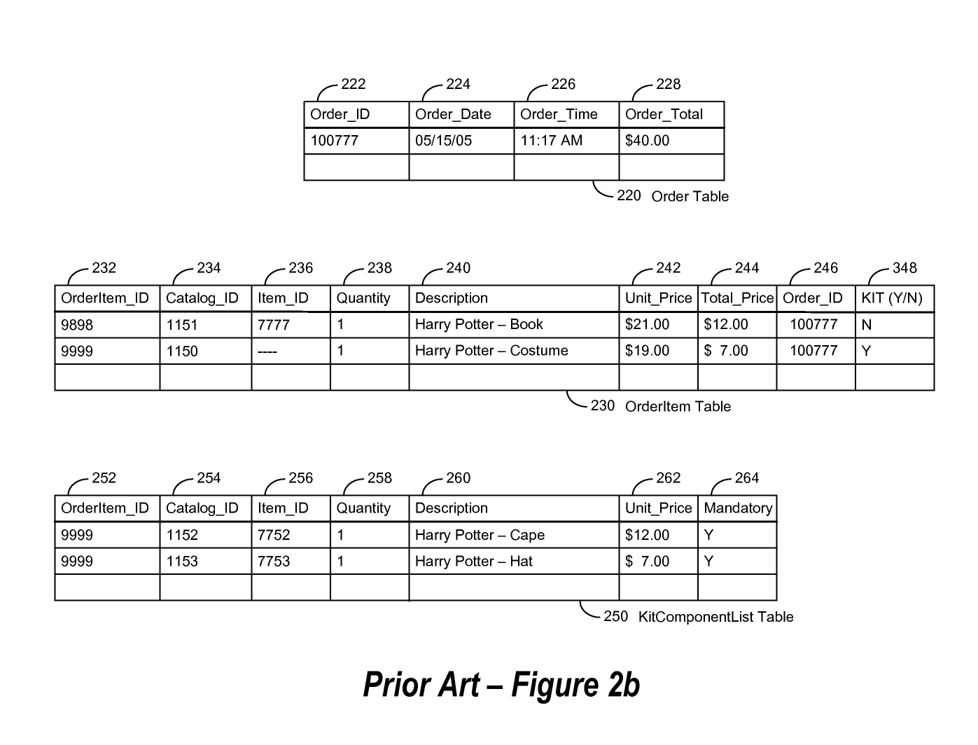

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

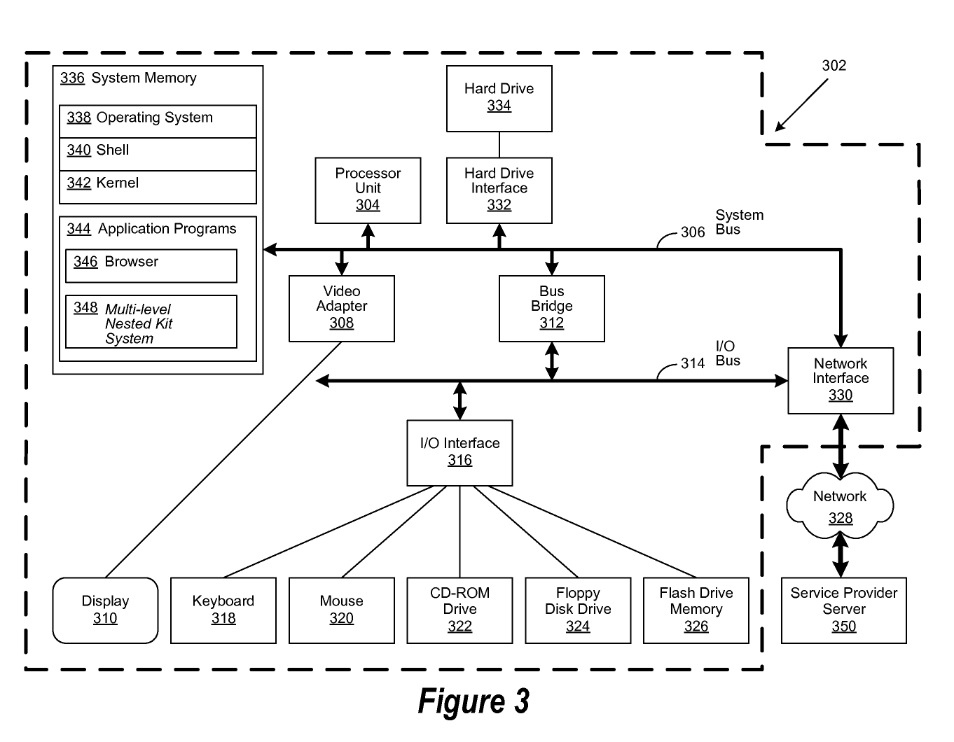

With reference now to FIG. 3, there is depicted a block diagram of an exemplary computer 302, in which the present invention may be utilized. Computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk—Read Only Memory (CD-ROM) drive 322, a floppy disk drive 324, and a flash drive memory 326. The format of the ports connected to I/0 interface 416 may be any known to those skilled in the art of computer architecture, including but not limited to Universal Serial Bus (USB) ports.

Computer 302 is able to communicate with a service provider server (which may also be a computer 350) via a network 328 using a network interface 330, which is coupled to system bus 306. Network 328 may be an external network such as the Internet, or an internal network such as an Ethernet or a Virtual Private Network (VPN). Using network 328, computer 302 is able to use the present invention to access service provider server 350.

A hard drive interface 332 is also coupled to system bus 306. Hard drive interface 332 interfaces with a hard drive 334. In one aspect of the present invention, hard drive 334 populates a system memory 336, which is also coupled to system bus 306. Data that populates system memory 336 includes client computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in a UNIX® operating system also called a command processor in a Microsoft® Windows® operating system, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., computer 302) to send and receive network messages to the Internet using HyperText Transfer Protocol (HTTP) messaging, thus enabling communication with service provider server 350.

Application programs 344 in client computer 302's system memory also include a multi-level nested kit system 348. Multi-level nested kit system 348 includes code for implementing the processes described in the. In one embodiment, computer 302 is able to download multi-level nested kit system 348 from service provider server 350.

The hardware elements depicted in computer 302 are not intended to be exhaustive, but rather are representative to highlight essential components required by the present invention. For instance, computer 302 may include alternate memory storage devices such as magnetic cassettes, Digital Versatile Disks (DVDs), Bernoulli cartridges, and the like. These and other variations are intended to be within the spirit and scope of the present invention.

As noted above, multi-level nested kit system 348 can be downloaded to a client computer from service provider server 350. Additionally, in one aspect of the present invention, service provider server 350 performs all of the functions associated with the present invention (including execution of multi-level nested kit system 348), thus freeing a client computer 302 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

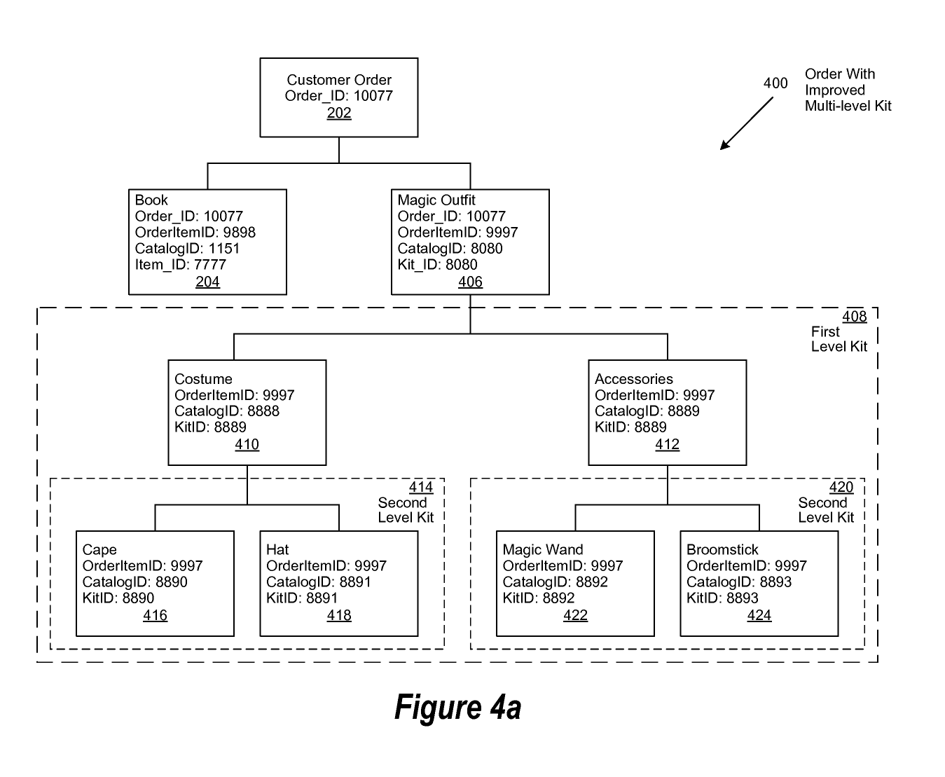

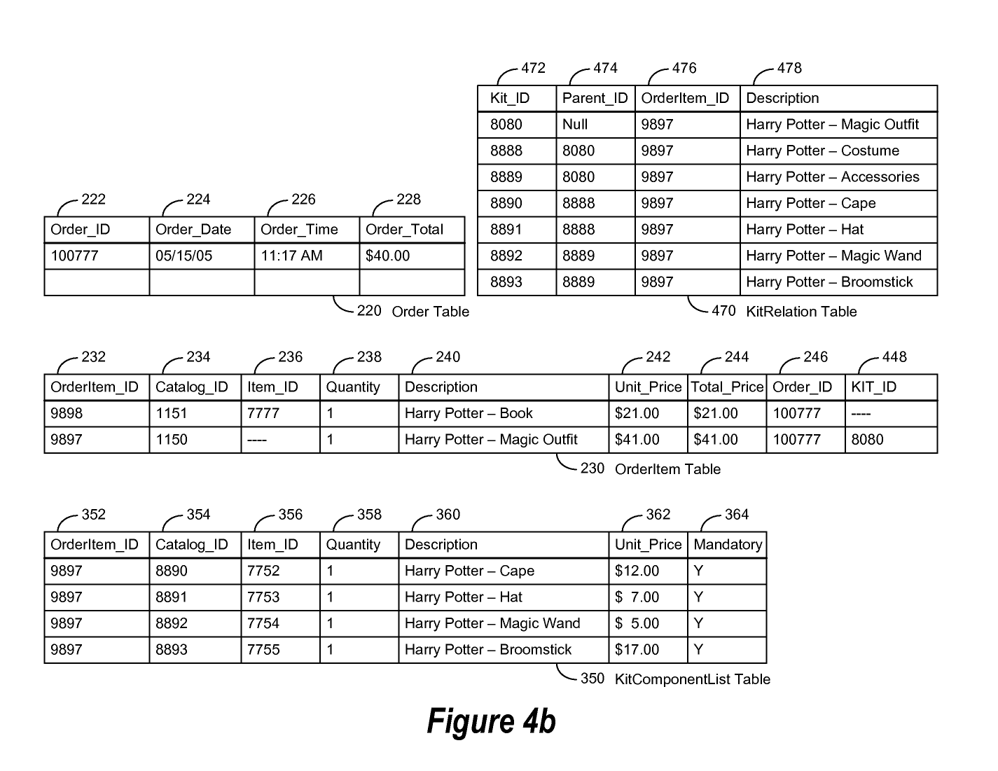

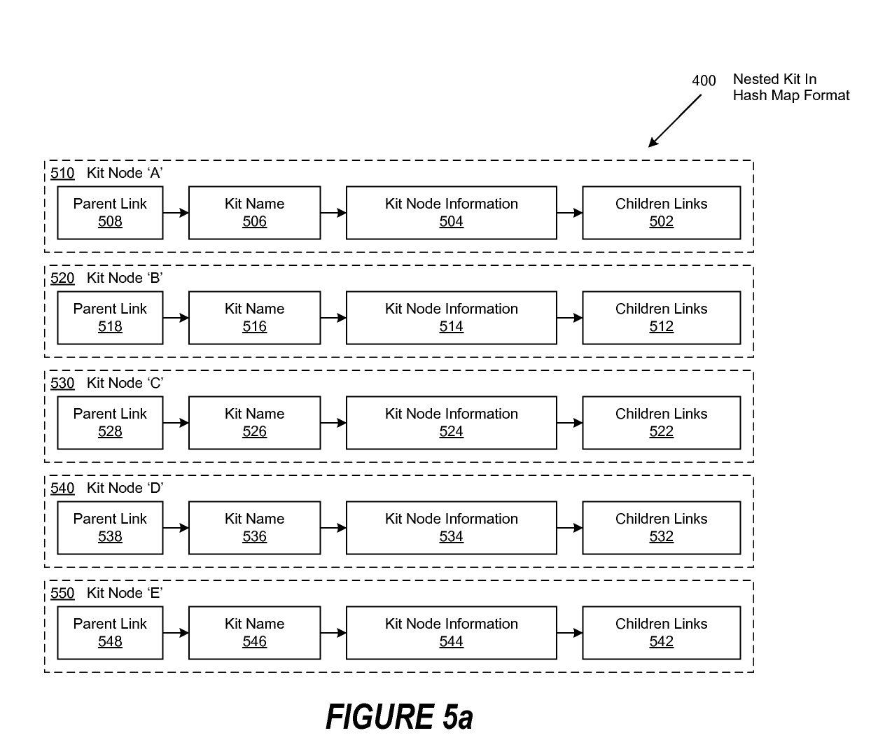

FIG. 4a-b depict a customer order comprising multi-level, nested kit components 400 as implemented in accordance with an embodiment of the invention. FIG. 4a shows customer order 202, comprising book 204 and magic outfit 406. Customer order 202 further comprises an Order_ID data field implemented as a relational link to book 204, and magic outfit 406, which likewise comprise an Order_ID data field depicted with the same value. Magic outfit multi-level kit 406 comprises first level kit 408, further comprising costume 410 and accessories 412. Costume first level kit 410 comprises second-level kit 414, further comprising kit components cape 416 and hat 418. First-level kit 412 similarly comprises second-level kit 420, further comprising kit components magic wand 422 and broomstick 424.

FIG. 4b shows Order database table 220, OrderItem database table 230, KitComponentList database table 350, and KitRelation database table 470 as implemented in accordance with an embodiment of the invention to assemble component items into a kits comprising one or more levels. Order database table 220 comprises database fields Order_ID 222, Order_Date 224, Order_Time 226, and Order_Table 228, but not individual order items. OrderItem database table 230 comprises database fields OrderItem_ID 232, Catalog_ID 234, Item_ID 236, item Quantity 238, item Description 240, item Unit_Price 242, item Total_Price 244, Order_ID 246, and KIT_ID 448. KitComponentList database table 350 comprises database fields OrderItem_ID 352, Catalog_ID 254, Item_ID 356, item Quantity 358, item Description 360, item Unit_Price 362, and logical field Mandatory 364. KitRelation database table 470 comprises database fields Kit_ID 472, Parent_ID 474, OrderItem_ID 476 and Description 478.

In an embodiment of the invention, the contents of database fields Order_ID 246, OrderItem_ID 232, and Catalog_ID 234 correspond respectively to book order item 204 and magic outfit multi-level kit 406 comprising customer order 202. In this embodiment, no alteration to the existing catalog database is required to implement the multi-level kit comprising magic outfit 406. The hierarchical level of each catalog item (e.g., costume 410, hat 418) within the kit is established by referencing the contents of database field Catalog_ID 354 comprising KitComponentList database table 350, to the contents of database fields Kit_ID 472 and Parent_ID 474, comprising KitRelation database table 470. In a similar manner, the value of logical field Mandatory 364 signifies whether items (e.g., cape 416, hat 418) sharing the same value of database fields OrderItem_ID 352 and 232 comprising KitComponentList database table 350, and OrderItem database table 230 respectively, are mandatory components comprising the same kit.

The addition of KitRelation database table 470 allows nested kit relationship information to be self contained. Furthermore, it allows information contained within KitRelation database table 470 to be restricted to those components comprising a predetermined kit (e.g., physically inventoried items). In an embodiment of the invention, implementation of KitRelation database table 470 reduces the need for modifications to inventory and pricing routines that are dependent upon information related to physically inventoried items. Furthermore, packslip generation and display navigation is facilitated by providing a single and consolidated point of access for all kit component relationship information. Additionally, the KitComponentList database table 250 is reduced in size as it only contains the physical entities and not logical constructs (e.g., a kit). As a result, the need for modifying pricing and inventory routines is reduced, as well as the need for testing during application migrations.

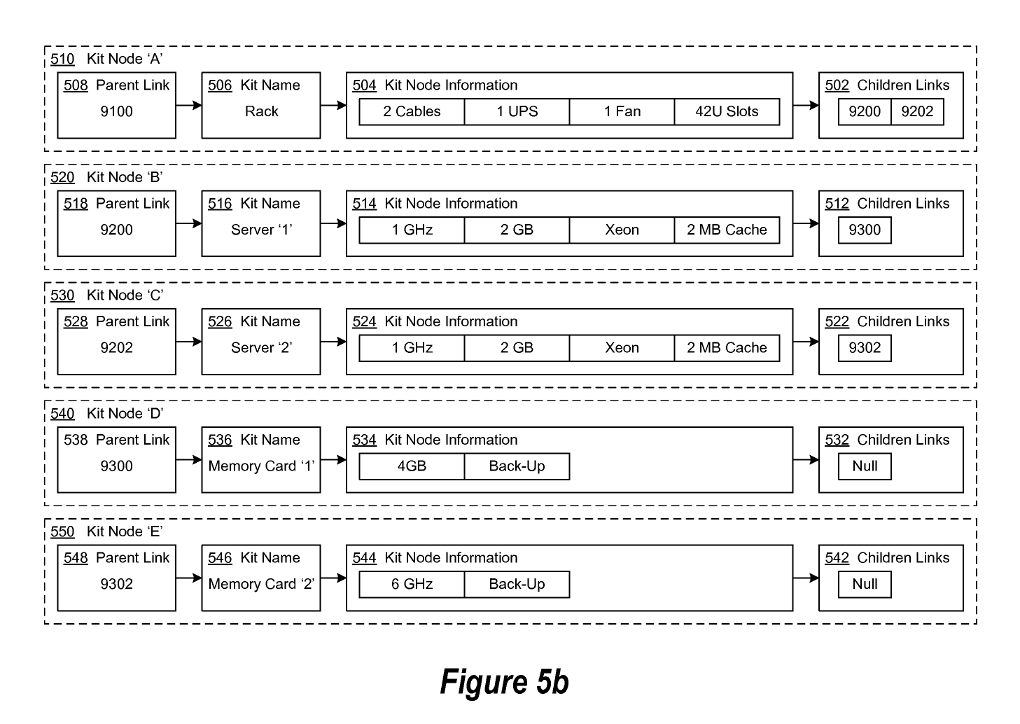

FIGS. 5a-b depict a block diagram of a nested kit in a hash map format 500 as implemented in accordance with an embodiment of the invention. As depicted in FIG. 5a, each entry in the hashmap is a kit node of a nested kit tree. Each of these kit nodes 510, 520, 530, 540, 550 is referenced by its name 506, 516, 526, 536, 546, and possesses information 504, 514, 524, 534, 544 about itself. In addition, each kit node possesses a link to its parent kit node 508, 518, 528, 538, 548, and links to its children kit nodes 502, 512, 522, 532, 542. Implementation of the hash-map provides direct access to any kit node on the nested kit tree without requiring computationally-expensive traversal of the nested kit tree.

FIG. 5b depicts an exemplary embodiment of the invention as implemented for a rack of blade servers. In this depiction, kit node ‘A’ 510 comprises server rack 506 with associated information 504 and links to its parent 508 and children 502. Kit node ‘B’ 520 likewise comprises server ‘1’ 516 with associated information 514 and links to its parent 518 and children 512, just as Kit node ‘C’ 530 comprises server ‘2’ 526 with associated information 524 and links to its parent 528 and children 522. In a likewise manner, kit node ‘D’ 540 comprises memory card ‘1’ 536 with associated information 534 and links to its parent 538 and children 532, with kit node ‘E’ 550 comprising memory card ‘2’ 546 with associated information 544 and links to its parent 548 and children 542.

It will be appreciated that implementation of the hash map allows each item comprising its related kit node 510, 520, 530, 540, 550 to be associated with a key. As a result, the hash map provides random access to each item comprising a kit, thereby improving display navigability by allowing predetermined item information to be directly accessed for retrieval. Otherwise, selecting a predetermined item for display would require complete traversal of a tree-like structure before the item is discovered and its associated information retrieved.

For example, to access and display predetermined information associated with memory card ‘2’ 546 without implementation of the hash map, kit node ‘A’ 510 must first be selected and traversed to discover its children links 502. Once it is traversed, and if the predetermined information is not discovered, the first child link 502 (‘9200’) is followed to the parent link 518 of kit node ‘B’ 520, which is then traversed. If the predetermined information is not discovered after traversal, its child link 512 (‘9300’) is followed to the parent link 538 of kit node ‘D’ 540, which is then traversed. If the predetermined information is still not discovered after traversal, and if child link 532 is ‘null’, then the second child link 502 (‘9302’) of kit node ‘A’ 510 is followed to the parent link 528 of kit node ‘C’ 530, which is then traversed. If the predetermined information is not discovered after traversal, then its child link 532 is followed to the parent link 548 of kit node ‘E’ 550, which is then traversed. During traversal of kit node ‘E’ 550, kit node information 544 associated with memory card ‘2’ 546 is discovered, retrieved, and displayed. However, with implementation of the hash map, kit node information 544 associated with memory card ‘2’ 546 is directly accessible for retrieval and display. In addition, packslip generation routines that rely on in-memory representation are rendered more efficient as the hashmap's flexible representation reduce tree structure traversals, thereby shortening overall order processing times.

The multi-level nested kit system 148 provides significant reduction in migration problems, reduces chances of introduction of new bugs by not requiring the modification of pricing and inventory routines, improves efficiency of pack-slip generation routines by providing improved representation of nested kits in-memory, and helps improve navigability from the user's display point of view.

With the HashMap, the identifiers function as a key to enable the mutli-level nested kit system 148 to access an entry associated with a particuarl key. When a user actuates any part of the display, the associated key assists in making a direct access to that node and then displays the details associated with that node.

The HashMap of nodes improves navigability for display purposes, as well as for making a packslip generation routing more efficient, reducing order processing time. (The packslip generation routine relies on in-memory representation, while inventor, pricing, etc., generally use stored procedures and thus the tables directly). With the HashMap representation any entry can be accessed directly, one the key for the entry is known. Accessing the entry directly is thus faster than a process which does not provide for a direct access and instead must traverse a tree like structure to get to a desired entry. Thus when a user, who has a display of a server, (e.g., server 2), now wishes to view a rack, the key corresponding to the rack can be used to make a direct access to the rack and display all its details (and any images if applicable).

The HashMap representation makes it quick to navigate, allowing for rapid generation of the packslip generation routine which requires the traversal of the entire nested kit tree. Additionally, more information can be stored at any node of the tree, allowing for presentation of greater detail or further ease of navigability (by having additional links).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method comprising:
storing physical components of a nested kit in an order item table of a database;
storing the entire nested kit relationship in a separate table; and
providing a representation of the nested kit as a hash map of nodes where each node is aware of a node parent relationship and node children relationship.

2. A method of claim 1 wherein:
each entry in the hash map comprises information about the entry.

3. A method of claim 1 wherein:
each entry in the hash map comprises a link to the node parent and the node children.

4. The method of claim 1 wherein:
each entry in the hash map comprises a link to a parent and a child of the entry.

5. The method of claim 1 wherein:
upon actuation of a part of a display, an associated key assists in making a direct access to a node corresponding to the key and displays details associated with the node corresponding to the key.

6. The method of claim 1 further comprising:
facilitating packslip generation by relying on the representation of the node.

7. A system comprising:
a processor;
a data bus coupled to the processor; and
a computer-usable medium embodying computer program code, the computer-usable medium being coupled to the data bus, the computer program code comprising instructions executable by the processor and configured for:
storing physical components of a nested kit in an order item table of a database; and,
providing an in memory representation of the nested kit as a hash map of nodes where each node is aware of a node parent relationship and node children relationship.

8. The system of claim 7, wherein:
each entry in the hash map comprises information about the entry.

9. A system of claim 7 wherein:
each entry in the hash map comprises a link to the node parent and the node children.

10. The system of claim 7 wherein:
each entry in the hash map comprises a link to a parent and a child of the entry.

11. The system of claim 7 wherein:
upon actuation of a part of a display, an associated key assists in making a direct access to a node corresponding to the key and displays details associated with the node corresponding to the key.

12. The system of claim 7 wherein:
the hash map nodes facilitate packslip generation by relying on the in memory representation of the node.

13. A computer program product comprising:
a computer usable medium having computer usable program code embodied therewith, the computer usable program code comprising
computer usable program code configured to store physical components of a nested kit in an order item table of a database; and
computer usable program code configured to provide a representation of the nested kit as a hash map of nodes where each node is aware of a node parent relationship and node children relationship.

14. The computer program product of claim 13, wherein:
each entry in the hash map comprises information about the entry.

15. The computer program product of claim 13 wherein:
each entry in the hash map comprises a link to the node parent and the node children.

16. The computer program product of claim 13 wherein:
each entry in the hash map comprises a link to a parent and a child of the entry.

17. The computer program product of claim 13 wherein:
upon actuation of a part of a display, an associated key assists in making a direct access to a node corresponding to the key and displays details associated with the node corresponding to the key

18. The computer program product of claim 13 wherein:
the hash map nodes facilitate packslip generation by relying on the in memory representation of the node.
